(19) United States
(12) Patent Application Publication
(10) Pub. No.: US 2022/0104012 A1
(43) Pub. Date: Mar. 31, 2022

(54) AUTHENTICATION PROCESSING METHOD AND DEVICE, STORAGE MEDIUM AND ELECTRONIC DEVICE

(71) Applicant: ZTE Corporation, Shenzhen (CN)

(72) Inventors: Jin PENG, Shenzhen (CN); Shilin YOU, Shenzhen (CN); Zhenhua XIE, Shenzhen (CN); Wantao YU, Shenzhen (CN); Zhaoji LIN, Shenzhen (CN); Wei CAO, Shenzhen (CN)

(21) Appl. No.: 17/423,629

(22) PCT Filed: Jan. 19, 2020
(86) PCT No.: PCT/CN2020/072948

§ 371 Date: Jul. 16, 2021

(30) Foreign Application Priority Data
Jan. 18, 2019 (CN) 201910049948.9

(51) Int. Cl. H04W 12/06; H04W 12/0431; H04W 12/122; H04W 12/106

(52) U.S. Cl. CPC H04W 12/06; H04W 12/106; H04W 12/122; H04W 12/0431

(57) ABSTRACT

Provided are an authentication processing method and device, a storage medium and an electronic device, the method includes: a terminal receives a first authentication request message from a network side; the terminal determines whether the number of times of receiving the first authentication request message is greater than a predetermined threshold; and when the number of times is greater than the predetermined threshold, the terminal stops responding to the first authentication request message.

This disclosure claims priority to Chinese Patent Application No. 201910049948.9, filed with the Chinese Patent Office on Jan. 18, 2019, the disclosure of which is incorporated herein by reference in its entirety.

### TECHNICAL FIELD

The present disclosure relates to the field of communications, and for example, to an authentication processing method and device, storage medium and electronic device.

### BACKGROUND

The 3rd Generation Partnership Project (3GPP) formulates various mobile networks specifications, including the Authentication and Key Agreement (AKA), which is used for mutual authentication between a terminal (For example, a UE) and a network and creating a shared key.

In the process of AKA, when a terminal receives an authentication request message from a network, the terminal may verify the message, and if the verification fails, the terminal responds with an authentication failure message, which carries a failure cause parameter. If the authentication request message is not a legal authentication request message for the terminal, the failure cause is a MAC Failure. If the authentication request message is a legal authentication request message for the terminal, but the message has been verified by the terminal due to replay, the failure cause is Sync Failure.

In such an authentication mechanism, if an attacker replays a legal authentication request message, receives an authentication failure message responded by a terminal, and analyzes the failure cause in the authentication failure message, the terminal corresponding to the authentication request message can be distinguished, so that it can be determined whether a specific terminal exists in a certain area. By replaying the authentication request message multiple times, and receiving and analyzing the authentication failure message, the attacker can track a user and may further attack the user's privacy.

Aiming at the above problems in the related art, there is no effective solution has been provided at present.

### SUMMARY

Embodiments of the present disclosure provide an authentication processing method and device, storage medium and electronic device, so as to at least solve the problem in the related art that tracing of a terminal can be realized by replaying a legal authentication request message many times under an AKA authentication mechanism.

According to an embodiment of the present disclosure, provided is an authentication processing method, comprising: a terminal receives a first authentication request message from a network side; the terminal determines whether the number of times of receiving the first authentication request message is greater than a predetermined threshold; the terminal stop responding to the first authentication request message when the number of times is greater than the predetermined threshold.

According to another embodiment of the present disclosure, an authentication processing device is provided, which is applied to a terminal. The device comprises: a receiving module, configured to receive a first authentication request message from a network side; a determining module, configured to determine whether the number of times that the first authentication request message is received is greater than a predetermined threshold; a processing module, configured to stop responding to the first authentication request message when the number of times is greater than the predetermined threshold value.

According to another embodiment of the present disclosure, also provided is a storage medium. The storage medium stores a computer program, wherein the computer program is configured to run to execute the steps of the method in the above embodiments.

According to another embodiment of the present disclosure, also provided is an electronic device, comprising a memory and a processor, wherein the memory stores a computer program, and the processor is configured to run the computer program so as to execute the steps of the method in the above embodiments.

Through the present disclosure, after receiving the authentication request message from the network side, the judgment of whether the number of times of receiving the authentication request message is greater than a predetermined threshold is added, and when the number of times of receiving the authentication request message is greater than the predetermined threshold, the response to the authentication request message is stopped. The attacker can be effectively prevented from obtaining a sufficiently large authentication failure message for tracking the user, and the problem of tracking the terminal can be realized by playing a legal authentication request message multiple times under the AKA authentication mechanism in the related art, and the security and confidentiality of the authentication process are effectively improved.

### BRIEF DESCRIPTION OF THE DRAWINGS

Drawings, provided for further understanding of the present disclosure and forming a part of the present disclosure, are used to explain the present disclosure together with embodiments of the present disclosure rather than to limit the present disclosure. In the drawings:

FIG. 1 is a hardware structure block diagram of a mobile terminal for an authentication processing method according to an embodiment of the present disclosure;

FIG. 2 is a flowchart of an authentication processing method according to Embodiment 1 of the present disclosure;

FIG. 3 is a first optional flowchart of an authentication processing method according to Embodiment 1 of the present disclosure;

FIG. 4 is a second optional flowchart of the authentication processing method according to embodiment one of the present disclosure;

FIG. 5 is a third optional flowchart of an authentication processing method according to Embodiment one of the present disclosure;

FIG. 6 is a structure diagram of an authentication processing device according to Embodiment two of the present disclosure;

FIG. 7 is a first optional structure block diagram of an authentication processing device according to Embodiment two of the present disclosure;

FIG. 8 is a second optional structural block diagram of an authentication processing device according to Embodiment two of the present disclosure;

FIG. 9 is a third optional structure block diagram of an authentication processing device according to Embodiment two of the present disclosure;

FIG. 10 is a schematic structural diagram of a mobile system according to Embodiment four;

FIG. 11 is a flow diagram of an AKA authentication in accordance with the 5G technique of Embodiment four;

FIG. 12 is a schematic diagram of a terminal authentication flow according to Embodiment five of the present disclosure.

### DETAILED DESCRIPTION OF THE EMBODIMENTS

The present disclosure will be described below with reference to the drawings and embodiments in detail. It is important to note that the embodiments of the present disclosure and the characteristics in the embodiments can be combined under the condition of no conflicts.

It should be noted that the terms “first” and “second” in the description, claims, and accompanying drawings of the present disclosure are used to distinguish similar objects, and are not necessarily used to describe a specific sequence or order.

### Embodiment One

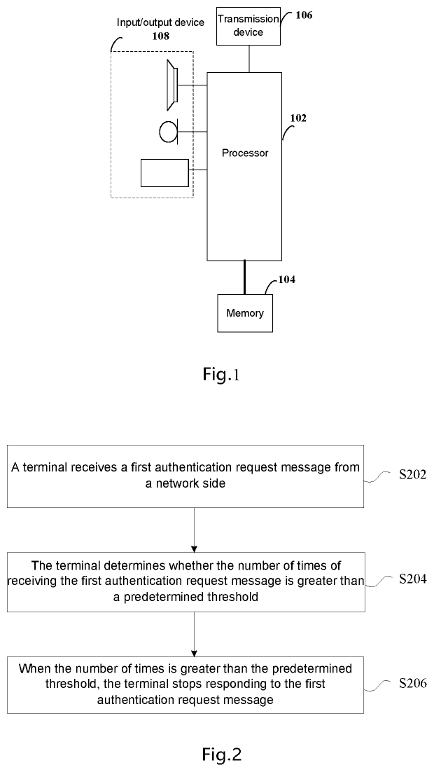

The method provided in this embodiment of the present disclosure may be executed in a terminal (such as a mobile terminal, a computer terminal, or a similar computing device). Taking the mobile terminal as an example, FIG. 1 is a hardware structure block diagram of a mobile terminal with an authentication processing method according to an embodiment of the present disclosure. As shown in FIG. 1, the mobile terminal 10 may include one or more (only one is shown in FIG. 1), a processor 102 (processor 102 may include, but is not limited to, a microprocessor MCU or a processing device of a programmable logic device FPGA or the like) and a memory 104 for storing data, and optionally, the mobile terminal 10 may further include a transmission device 106 and an input/output device 108 for a communication function. A person of ordinary skill in the art may understand that the structure shown in FIG. 1 is merely exemplary, which does not limit the structure of the foregoing mobile terminal. For example, the mobile terminal 10 may also include more or fewer components than shown in FIG. 1, or have a different configuration than that shown in FIG. 1.

The memory 104 may be configured to store a computer program, for example, a software program and a module of disclosure software, such as a computer program corresponding to the authentication processing method in the embodiment of the present disclosure. The processor 102 runs the computer program stored in the memory 104, so as to execute various function disclosures and data processing, that is, to implement the foregoing method. Memory 104 may include high-speed random access memory, and may also include non-volatile memory, such as one or more magnetic storage devices, flash memory, or other non-volatile solid-state memory. In some instances, the memory 104 may further include memory remotely located from the processor 102, which may be connected to the mobile terminal 10 over a network. Examples of such networks include, but are not limited to, the Internet, intranets, local area networks, mobile communication networks, and combinations thereof.

The transmitting device 106 is configured to receive or transmit data via a network. Specific examples of the described network may include a wireless network provided by a communication provider of the mobile terminal 10. In one example, the transmitting device 106 includes a Network interface Controller (NIC) that may be coupled to other network devices via a base station to communicate with the Internet. In one example, the transmitting device 106 may be a Radio Frequency (RF) module for communicating wirelessly with the Internet.

Provided is an authentication processing method running on a terminal. FIG. 2 is a flowchart of an authentication processing method according to embodiment one of the present disclosure. As shown in FIG. 2, the flow comprises the following steps:

Step S202, the terminal receives a first authentication request message from the network side.

Step S204, the terminal determines whether the number of times of receiving the first authentication request message is greater than a predetermined threshold.

Step S206, the terminal stops responding to the first authentication request message when the number of times is greater than the predetermined threshold value.

Optionally, an execution subject of the foregoing steps may be a terminal, including but not limited to a mobile terminal, a computer terminal, or a similar computing device.

Through the present disclosure, after receiving the authentication request message from the network side, the judgment of whether the number of times of receiving the authentication request message is greater than a predetermined threshold is added, and when the number of times of receiving the authentication request message is greater than the predetermined threshold, the response to the authentication request message is stopped. The attacker can be effectively prevented from obtaining a sufficiently large authentication failure message for tracking the user, and the problem of tracking the terminal can be realized by playing a legal authentication request message multiple times under the AKA authentication mechanism in the related art, and the security and confidentiality of the authentication process are effectively improved.

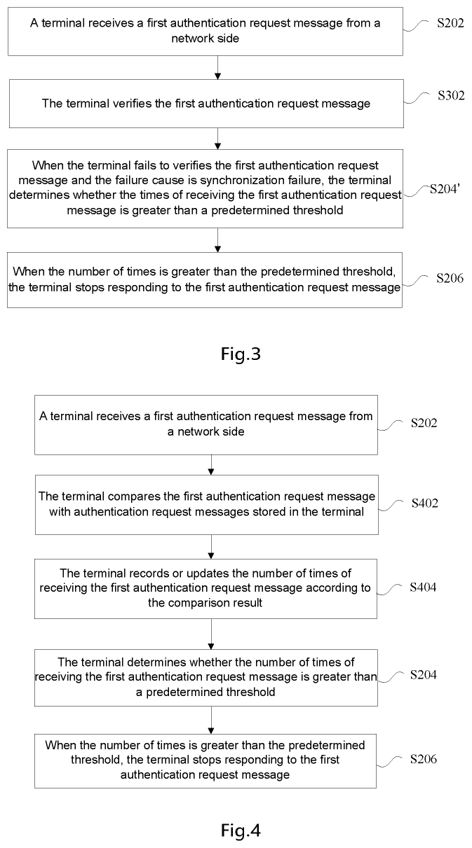

Given that the cause value in the authentication failure message received when the attacker replays a legal authentication request message is multi-indicated as synchronization failure, in an exemplary embodiment, as shown in a first optional flowchart of the authentication processing method according to Embodiment one of the present disclosure in FIG. 3. After receiving the first authentication request message from the network side in step S202, the method can further include:

Step S302, the terminal verifies the first authentication request message.

Herein, the Step S204 may specifically be step S204′: when the terminal fails to verify the first authentication request message and the failure cause is synchronization failure, the terminal determines whether the number of times of receiving the first authentication request message is greater than a predetermined threshold.

By means of the method, a potential attacker can be pertinently monitored to replay a legal authentication request message to track a terminal, so that on the premise of effectively avoiding an attack, the processing of a normal authentication request is not influenced as far as possible.

In an exemplary embodiment, as shown in a second optional flowchart of the authentication processing method according to Embodiment 1 of the present invention in FIG. 4, after the terminal receives the first authentication request message from the network side in step S202, the method may further include:

Step S402, the terminal compares the first authentication request message with the authentication request message stored in the terminal.

Step S404, the terminal records or updates the times of receiving the first authentication request message according to the comparison result.

In an exemplary embodiment, step S404 may comprise at least one of the following:

Step S404-1, in a situation that the authentication request message stored in the terminal does not include the first authentication request message, the terminal records the number of times of receiving the first authentication request message as 1;

Step S404-2, if the authentication request message stored in the terminal includes the first authentication request message, the terminal updates the times of receiving the first authentication request message.

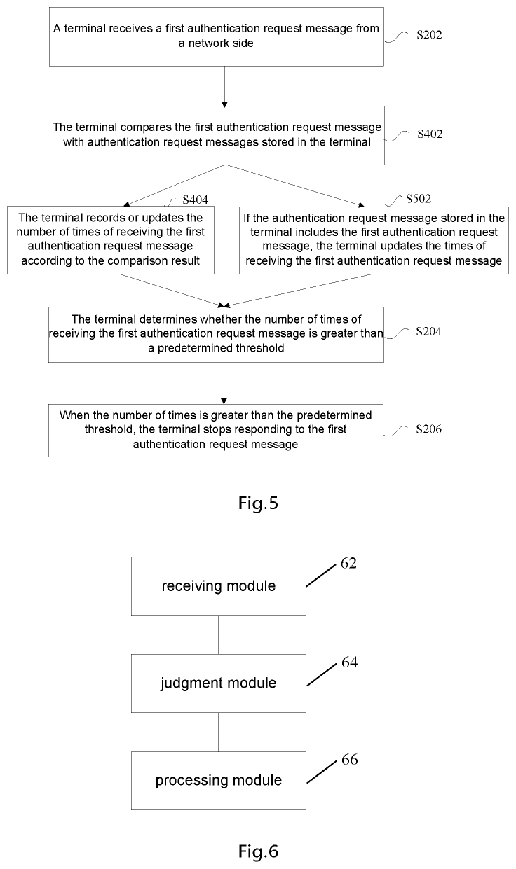

In an exemplary embodiment, as shown in a third optional flowchart of the authentication processing method according to Embodiment 1 of the present disclosure in FIG. 5, the method further includes:

Step S502, if the authentication request message stored in the terminal does not include the first authentication request message, the terminal stores the first authentication request message.

In the embodiments of the present disclosure, in the case where the number of times is not greater than the predetermined threshold, the terminal responds to the first authentication request message, for example, an authentication response message can be returned to the network side, and an authentication failure message or an authentication success message can be returned according to a specific verification situation.

Through the description of the foregoing embodiments, a person skilled in the art may clearly understand that the method according to the foregoing embodiments may be implemented by software in addition to a necessary universal hardware platform, and definitely may also be implemented by hardware. However, in many cases, the former is a preferred implementation. Based on such understanding, the technical solutions of the present disclosure can be embodied in the form of a software product. The computer software product is stored in a storage medium (such as a ROM/RAM, a magnetic disk, or an optical disk), and includes several instructions for enabling a terminal (which may be a mobile phone, a computer, a server, or a network device) to execute the methods described in the embodiments of the present disclosure.

### Embodiment Two

The embodiment further provides an authentication processing device, which is configured to implement the described embodiments and optional implementation modes, and what has been described will not be elaborated. The term “module”, as used hereinafter, is a combination of software and/or hardware capable of realizing a predetermined function. Although the device described in the following embodiment is preferably implemented by software, implementation of hardware or a combination of software and hardware is also possible and conceived.

FIG. 6 is a structure diagram of an authentication processing device according to Embodiment two of the present disclosure. As shown in FIG. 6, the device is applied to a terminal, and the device may include:

a receiving module 62, configured to receive a first authentication request message from a network side;

a judging component 64, configured to judge whether the number of times that the first authentication request message is received is greater than a predetermined threshold; and

a processing module 66, configured to stop the terminal responding to the first authentication request message when the number of times is greater than the predetermined threshold.

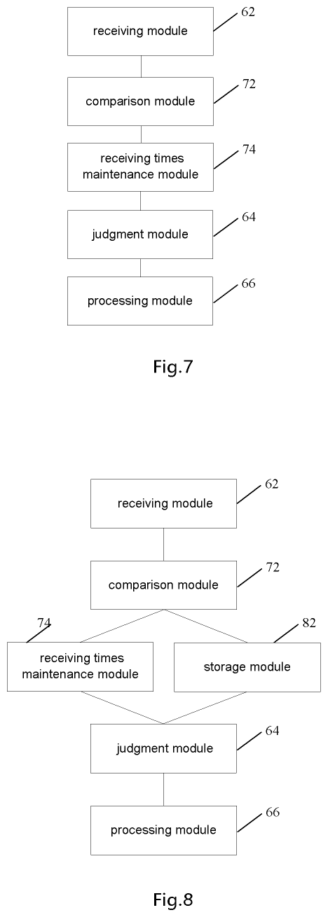

FIG. 7 is a first optional structural block diagram of an authentication processing device according to Embodiment two of the present disclosure. As shown in FIG. 7, the device further includes:

a comparison module 72, configured to compare the first authentication request message with the authentication request message stored in the terminal after the receiving module 62 receives the first authentication request message from the network side; and

a receiving times maintenance component 74, configured to record or update the times of receiving the first authentication request message according to the comparison result of the comparison component.

In an exemplary embodiment, the receiving times maintenance module 74 is configured to perform at least one of the following:

when the authentication request message stored in the terminal does not include the first authentication request message, the number of times of receiving the first authentication request message is record as 1;

when the first authentication request message is included in the authentication request messages that have been stored in the terminal, the number of times of receiving the first authentication request message is updated

FIG. 8 is a second optional structural block diagram of an authentication processing device according to Embodiment two of the present disclosure. As shown in FIG. 8, the device further includes a storing module 82.

The storing module 82 is configured to store the first authentication request message in the terminal if the authentication request message stored in the terminal does not include the first authentication request message.

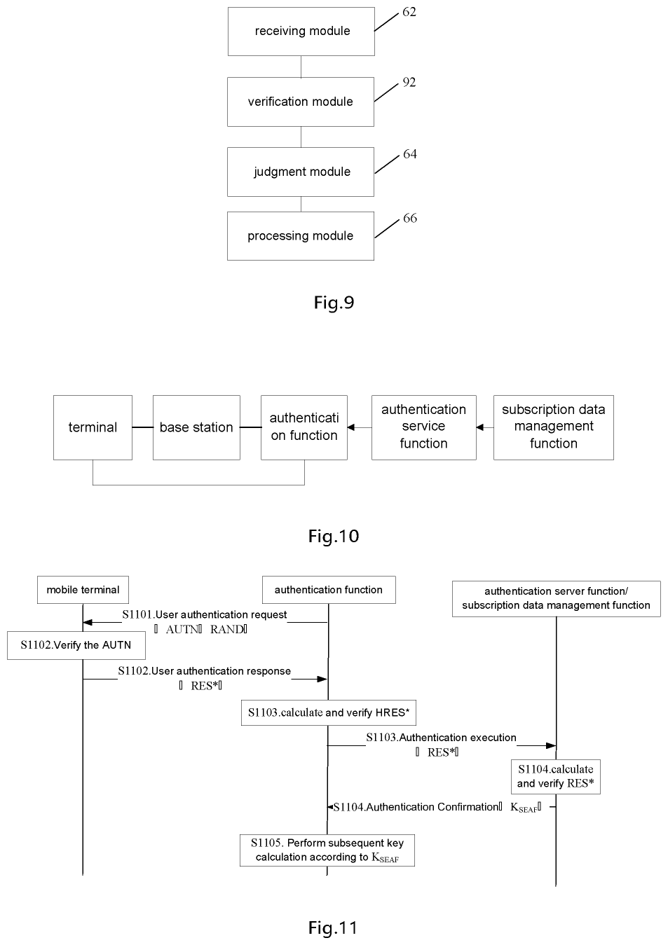

FIG. 9 is a third optional structural block diagram of an authentication processing device according to Embodiment two of the present disclosure. As shown in FIG. 9, the device further includes a verifying module 92.

The verifying module 92 is configured to verify the first authentication request message after the receiving module 62 receives the first authentication request message from the network side;

The judging module 64 is further configured to, when the verifying module 92 verifies that the first authentication request message fails and the failure cause is synchronization failure, judge whether the times of receiving the first authentication request message is greater than a predetermined threshold.

In the embodiment of the present disclosure, the processing module 66 is further configured to respond to the first authentication request message when the number of times is not greater than the predetermined threshold value, for example, return an authentication response message to the network side, and return an authentication failure message or an authentication success message according to a specific authentication situation.

It should be noted that each module may be implemented by software or hardware. The latter may be implemented in the following manner, but is not limited thereto. All the modules are located in a same processor; alternatively, the modules are located in different processors in an arbitrary combination.

### Embodiment Three

An embodiment of the present disclosure further provides a storage medium. The storage medium stores a computer program, wherein the computer program is configured to run to execute the steps in any one of the method embodiments.

Optionally, in this embodiment, the storage medium may be configured to store a computer program for executing the following steps:

S1, a terminal receives a first authentication request message from a network side.

S2, the terminal determines whether the number of times of receiving the first authentication request message is greater than a predetermined threshold.

S3, the terminal stops responding to the first authentication request message when the number of times is greater than the predetermined threshold value.

Optionally, in this embodiment, the storage medium may include, but is not limited to, any medium that can store a computer program, such as a USB flash drive, a Read-Only Memory (ROM for short), a Random Access Memory (RAM), a removable hard disk, a magnetic disk, or an optical disc.

An embodiment of the present disclosure also provides an electronic device, comprising a memory and a processor, wherein the memory stores a computer program, and the processor is configured to run the computer program so as to execute the steps in any one of the method embodiments.

Optionally, the electronic device can further comprise a transmission device and an input/output device, wherein the transmission device is connected to the processor, and the input/output device is connected to the processor.

Optionally, in this embodiment, the processor can be configured to execute the following steps by means of a computer program:

S1, a terminal receives a first authentication request message from a network side.

S2, the terminal determines whether the number of times of receiving the first authentication request message is greater than a predetermined threshold.

S3, the terminal stops responding to the first authentication request message when the number of times is greater than the predetermined threshold value.

Alternatively, for specific examples in this embodiment, reference may be made to the examples described in the foregoing embodiments and optional implementations, and details are not repeatedly described herein in this embodiment.

### Embodiment Four

FIG. 10 is a schematic structural diagram of a mobile system according to Embodiment four. As shown in FIG. 10, a network element of the mobile system related to an authentication and key negotiation process includes: a terminal (e.g., a UE), a base station, an authentication function, an authentication server function, and a subscription data management function. Each of them will be described in detail below.

A base station provides a terminal with services provided by various mobile networks, such as communications. In a practical system, the base station may be an access network element capable of providing communication services, such as an eNB or a gNB.

The authentication function is a software function or a hardware device of a core network of a mobile network, and is used for interacting with a base station through signaling, so that mutual authentication can be achieved between the mobile network and a terminal. In a practical system, the authentication function may be or may be provided in a network element such as Mobility Management Entity (MME), or Security Anchor Function (SEAF), or Access and Mobility Management Function (AMF).

The authentication server function is configured to acquire, through a signaling interface with the subscription data management function, key information related to a user, and provide the information to the authentication function through the signaling interface. In an actual system, the authentication server function may be or may be set in a network element such as an Authentication Server Function (AUSF), and the function may also be combined with a subscription data management function.

The subscription data management function is used for storing and processing user-related data, generating information used for authenticating a user and key information related to the user based on the user-related data, and providing the information to the authentication server function through a signaling interface. In a practical system, the subscription data management function may be or may be provided in a network element such as a User Date Management (UDM) or a Home Subscriber Server (HSS).

The AKA authentication technology may be applied to various communication networks. The whole procedure of the AKA authentication is briefly described below by taking the 5th generation (5G) communication network as an example. FIG. 11 is a flowchart of AKA authentication according to the 5G technology of Embodiment 4. As shown in FIG. 11, the specific steps are as follows:

Step S1101, an authentication function sends a user authentication request message to a terminal, where the message carries an AUTN and a RAND,

AUTN is an authentication token parameter, AUTN=(SQN⊕AK)∥AMF∥MAC, in which ∥ indicates performing a splicing operation, for example, 0011∥1111=00111111, SQN indicates a sequence number, AK indicates a anonymity Key, AMF indicates an authentication management field, and MAC indicates a message authenticate code.

RAND is a random number parameter.

The message may also carry a Key Set Identifier in 5G (ngKSI).

Step S1102, after receiving the user authentication request message, the terminal first calculates AK=F5K(RAND), then calculates SQN=(SQN⊕AK)⊕AK, then calculates XMAC=F1K(SQN∥RAND∥AMF), compares the XMAC with the MAC in AUTN, and if they are different, responds with an authentication failure message, the failure cause is “MAC Failure”. If if they are the same, it is verified whether the value of the SQN in the AUTN is within the correct range; in particular, if the SQN in the AUTN is larger than the SQN of the terminal, the SN is considered to be within the correct range, and if the SQN in the AUTN is smaller than or equal to the SQN of the terminal, the SN is considered to be within the incorrect range. If it is verified that the value of the SQN in the AUTN is not within the correct range, the terminal responds to the authentication failure message, and the failure cause is “Sync Failure”.

If the value of the SQN in the AUTN is within the correct range, the authentication is passed, and at this time, RES*=F2K(RAND) is calculated, and a user authentication request response message is sent to the authentication function, the message carrying RES*.

In this step, the involved⊕is an exclusive OR operation, ∥ still represents performing a splicing operation, XMAC is a expected MAC, F1K, F2K and F5K are key derivation functions using the root key K as a key, where F1K and F2K are message authentication functions, and F5K is a key generating function.

Step S1103, the authentication function derives an HRES* (namely, Hash Response*) from the RES* (namely, Response*), and then compares the HRES* with an HXRES* (namely, Hash expected Response*). If the comparison is passed, the visited network is successfully authenticated, and an authentication execution message is sent to the authentication server function/subscription data management function, and the RES* is carried in the message.

Step S1104, the authentication server function/subscription data management function compares RES* with XRES*, if they are equal, the authentication is successful in the home network, and an authentication confirmation message is returned to the authentication function, the message carrying a Subscription Permanent Identifier (SUPI) and an intermediate key KSEAF, wherein the intermediate key KSEAF is calculated by the AUSF.

Step S1105, the authentication function derives a KAMF from the intermediate key KSEAF, and then derives an access layer encryption key and an integrity protection key from the KAMF, and a non-access layer encryption key KNAS-enc and an integrity protection key.

### Embodiment Five

If the attacker replays a legal authentication request message, an authentication failure message responded by the terminal can be obtained after processing in step S1102 in Embodiment four, the failure cause in the authentication failure message is analyzed, the authentication request message is replayed many times, and the authentication failure message is received and analyzed, so that the attacker can track the user and may further attack the privacy of the users. In view of this problem, this embodiment provides an improved authentication processing manner in an authentication procedure of the terminal.

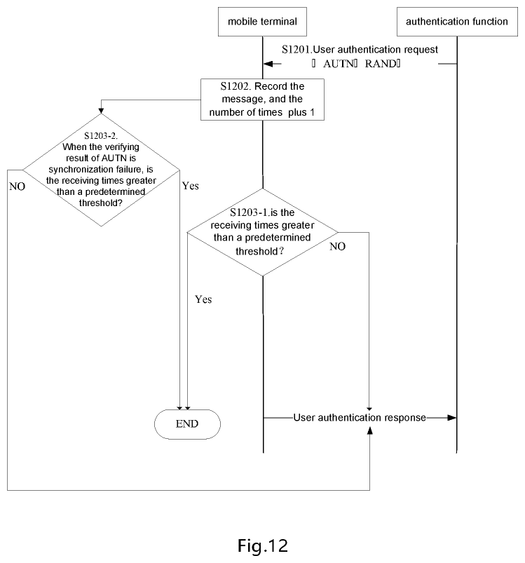

FIG. 12 is a schematic diagram of a terminal authentication flow according to Embodiment five of the present disclosure. The flow comprises:

Step S1201, a terminal receives an authentication request message from a network. The authentication token parameter (AUTN) and a random number parameter (RAND) are carried in the message.

Step S1202, the terminal records the number of times of receiving the authentication request message and the number of times of receiving the authentication request message. The terminal compares the received authentication request message with the stored message. If the received authentication request message is not stored, storing the message and setting the receiving times as 1; if the received authentication request message has been stored, 1 is added to the number of times of reception.

Step S1203 may have two parallel processing manners, specifically, S1203-1 and S1203-2.

Step S1203-1, the terminal judges the number of times of receiving the authentication request message. If the number of receipts is greater than the predetermined threshold, the authentication request message is not further processed.

Step S1203-2, the terminal authenticates the authentication request message. If the authentication fails and the failure cause is synchronization failure, the authentication server determines the times of receiving the authentication request message. If the number of receipts is greater than the predetermined threshold, the authentication request message is not further processed.

In the above method, if the number of times is equal to or smaller than the predetermined threshold, the terminal normally returns a user authentication response to the network side (the authentication function in this example).

Obviously, a person skilled in the art should understand that each module or each step of the present disclosure can be implemented by a universal computing device, and they can be centralized on a single computing device or distributed on a network composed of a plurality of computing devices, and optionally, they can be implemented by a program code executable by the computing device. Thus, they can be stored in a memory device and executed by a computing device, and in some cases, the illustrated or described steps can be executed in an order different from that here, or made into individual integrated circuit modules respectively, or made into individual integrated circuit modules. Thus, the present disclosure is not limited to any particular combination of hardware and software.

The foregoing descriptions are merely exemplary embodiments of the present disclosure, but are not intended to limit the present disclosure. For those skilled in the art, the present disclosure may have various modifications and variations. Any modifications, equivalent replacements, improvements and the like made within the present disclosure shall belong to the scope of protection of the present disclosure.

1. An authentication processing method, comprising:
receiving, a terminal, a first authentication request message from a network side;
determining, by the terminal, whether a number of times of receiving the first authentication request message is greater than a predetermined threshold;
stopping, by the terminal, responding to the first authentication request message when the number of times is greater than the predetermined threshold.

2. The method according to claim 1,
after the terminal receiving the first authentication request message from the network side, the method further comprises:
verifying, by the terminal, the first authentication request message;
determining, by the terminal, whether the number of times of receiving the first authentication request message is greater than a predetermined threshold comprises:
determining, by the terminal, whether the number of times of receiving the first authentication request message is greater than the predetermined threshold when the terminal fails to verify the first authentication request message and the failure cause is synchronization failure.

3. The method according to claim 1, wherein after the receiving, by the terminal, the first authentication request message from the network side, the method further comprises:
comparing, by the terminal, the first authentication request message with an authentication request message that has been stored in the terminal;
recording or updating, by the terminal, the number of times of receiving the first authentication request message according to the comparison result.

4. The method according to claim 3, wherein the step of the terminal recording or updating the times of receiving the first authentication request message according to the comparison result comprises at least one of:
when the authentication request message stored in the terminal does not comprise the first authentication request message, recording, the terminal, the number of times of receiving the first authentication request message as 1;
updating, by the terminal, the times of receiving the first authentication request message when the authentication request message stored in the terminal comprises the first authentication request message.

5. The method according to claim 4, further comprising:
storing, by the terminal, the first authentication request message when the authentication request message stored in the terminal does not include the first authentication request message.

6. An authentication processing device, applied to a terminal, comprising:
a receiving module, configured to receive a first authentication request message from a network side;
a determining module, configured to determine whether a number of times of receiving the first authentication request message is greater than a predetermined threshold;
a processing module, configured to stop responding to the first authentication request message when the number of times is greater than the predetermined threshold.

7. The device according to claim 6, further comprising:
a verifying module, configured to verify the first authentication request message after the receiving module receives the first authentication request message from the network side;
the judgment module, configured to judge whether the number of times of receiving the first authentication request message is greater than the predetermined threshold when the verification module fails to verify the first authentication request message and the failure cause is synchronization failure.

8. The device according to claim 6, further comprising:
a comparison module, configured to compare the first authentication request message with authentication request messages stored in the terminal after the receiving module receives the first authentication request message from the network side;
a receiving times maintenance module, configured to record or update the number of times of receiving the first authentication request message according to a comparison result from the comparison module.

9. The device according to claim 8, wherein the receiving times maintenance module is configured to perform at least one of the following:
when the authentication request message stored in the terminal does not comprise the first authentication request message, record the number of times of receiving the first authentication request message as 1;
update the number of times of receiving the first authentication request message when the authentication request message stored in the terminal comprises the first authentication request message.

10. The device according to claim 9, further comprising:
a storing module, configured to store the first authentication request message in the terminal if the authentication request message stored in the terminal does not include the first authentication request message.

11. A non-transitory storage medium, a computer program is stored in the storage medium, wherein the computer program is configured to run to execute the method as claimed in claim 1.

12. An electronic device, comprising a memory and a processor, wherein a computer program is stored in the memory, and the processor is configured to run the computer program to execute the method as claimed in claim 1.

13. The method according to claim 2, wherein after the receiving, by the terminal, the first authentication request message from the network side, the method further comprises:
comparing, by the terminal, the first authentication request message with an authentication request message that has been stored in the terminal;
recording or updating, by the terminal, the number of times of receiving the first authentication request message according to the comparison result.

14. The device according to claim 7, further comprising:
a comparison module, configured to compare the first authentication request message with authentication request messages stored in the terminal after the receiving module receives the first authentication request message from the network side;
a receiving times maintenance module, configured to record or update the number of times of receiving the first authentication request message according to a comparison result from the comparison module.

15. A non-transitory storage medium, a computer program is stored in the storage medium, wherein the computer program is configured to run to execute the method as claimed in claim 2.

16. A non-transitory storage medium, a computer program is stored in the storage medium, wherein the computer program is configured to run to execute the method as claimed in claim 3.

17. A non-transitory storage medium, a computer program is stored in the storage medium, wherein the computer program is configured to run to execute the method as claimed in claim 4.

18. A non-transitory storage medium, a computer program is stored in the storage medium, wherein the computer program is configured to run to execute the method as claimed in claim 5.

19. An electronic device, comprising a memory and a processor, wherein a computer program is stored in the memory, and the processor is configured to run the computer program to execute the method as claimed in claim 2.

20. An electronic device, comprising a memory and a processor, wherein a computer program is stored in the memory, and the processor is configured to run the computer program to execute the method as claimed in claim 3.
